(19) United States
(12) Patent Application Publication
(10) Pub. No.: US 2014/0281236 A1
(43) Pub. Date: Sep. 18, 2014

(54) SYSTEMS AND METHODS FOR IMPLEMENTING TRANSACTIONAL MEMORY

(71) Applicants: William C. Rash, Saratoga, CA (US); Scott D. Hahn, Portland, OR (US); Bret L. Toll, Hillsboro, OR (US); Glenn J. Hinton, Portland, OR (US)

(72) Inventors: William C. Rash, Saratoga, CA (US); Scott D. Hahn, Portland, OR (US); Bret L. Toll, Hillsboro, OR (US); Glenn J. Hinton, Portland, OR (US)

(21) Appl. No.: 13/803,658

(22) Filed: Mar. 14, 2013

(51) Int. Cl. G06F 12/00

(52) U.S. Cl. CPC G06F 12/00
USPC 711/122; 711/154; 711/118

(57) ABSTRACT

Systems and methods for implementing transactional memory access. An example method may comprise initiating a memory access transaction; executing a transactional read operation, using a first buffer associated with a memory access tracking logic, with respect to a first memory location, and/or a transactional write operation, using a second buffer associated with the memory access tracking logic, with respect to a second memory location; executing a non-transactional read operation with respect to a third memory location, and/or a non-transactional write operation with respect to a fourth memory location; responsive to detecting, by the memory access tracking logic, access by a device other than the processor to the first memory location or the second memory location, aborting the memory access transaction; and completing, irrespectively of the state of the third memory location and the fourth memory location, the memory access transaction responsive to failing to detect a transaction aborting condition.

### FIELD

The present disclosure is generally related to computer systems, and is specifically related to systems and methods for implementing transactional memory.

### BACKGROUND

Concurrent execution of two or more processes may require a synchronization mechanism to be implemented with respect to a shared resource (e.g., a memory accessible by two or more processors). One example of such synchronization mechanism is a semaphore-based locking, which results in serialization of process execution, thus potentially adversely affecting the overall system performance. Furthermore, semaphore-based locking may result in a deadlock (a condition occurring when two or more processes are each waiting for another to release a resource lock).

### BRIEF DESCRIPTION OF THE DRAWINGS

The present disclosure is illustrated by way of examples, and not by way of limitation, and may be more fully understood with references to the following detailed description when considered in connection with the figures, in which:

FIG. 1 depicts a high-level component diagram of an example computer system, in accordance with one or more aspects of the present disclosure;

FIG. 2 depicts a block diagram of a processor, in accordance with one or more aspects of the present disclosure;

FIGS. 3a-3b schematically illustrate elements of a processor micro-architecture, in accordance with one or more aspects of the present disclosure;

FIG. 4 illustrates several aspects of an example computer system implementing transactional memory access, in accordance with one or more aspects of the present disclosure;

FIG. 5 is an example code fragment illustrating the use of transactional mode instructions, in accordance with one or more aspects of the present disclosure;

FIG. 6 depict a flow diagrams of a method for implementing transactional memory access, in accordance with one or more aspects of the present disclosure; and

FIG. 7 depicts a block diagram of an example computer system, in accordance with one or more aspects of the present disclosure.

### DETAILED DESCRIPTION

Described herein are methods and systems for implementing transactional memory access by computer systems. “Transactional memory access” shall refer to executing, by a processor, two or more memory access instructions as an atomic operation so that the instructions either collectively succeed or collectively fail. In the latter situation, the memory may remain unmodified in the state existing before executing the first of the sequence of operations, and/or other corrective actions may be performed. In certain implementations, transactional memory access may be executed speculatively, i.e., without locking the memory being accessed, thus providing an efficient mechanism for synchronizing access to a shared resource by two or more concurrently executing threads and/or processes.

To implement transactional memory access, the processor instruction set may include a transaction start instruction and a transaction end instruction. In the transactional mode of operation, the processor may speculatively perform a plurality of memory read and/or memory write operations via respective read buffers and/or write buffers. The write buffers may hold results of memory write operations without committing the data to the corresponding memory locations. A memory tracking logic associated with the buffer may detect another device's access to the specified memory locations, and signal the error condition to the processor. Responsive to receiving the error signal, the processor may abort the transaction and transfer the control to an error recovery routine. Alternatively, the processor may check for errors when reaching the transaction end instruction. In the absence of transaction aborting conditions, the processor may commit the write operation results to the corresponding memory or cache locations. In the transactional mode of operation, the processor may also execute one or more memory read and/or write operations which may be immediately committed such that their results immediately become visible to other devices (e.g., other processor cores or other processors), irrespectively of the transaction successful completion or aborting. The ability to perform non-transactional memory access within a transaction provides a better flexibility in processor programming and increases the overall execution efficiency by potentially reducing the number of transactions necessary to accomplish a given programming task.

Various aspects of the above referenced methods and systems are described in details herein below by way of examples, rather than by way of limitation.

In the following description, numerous specific details are set forth, such as examples of specific types of processors and system configurations, specific hardware structures, specific architectural and micro architectural details, specific register configurations, specific instruction types, specific system components, specific measurements/heights, specific processor pipeline stages and operation etc. in order to provide a thorough understanding of the present invention. It will be apparent, however, to one skilled in the art that these specific details need not be employed to practice the present invention. In other instances, well known components or methods, such as specific and alternative processor architectures, specific logic circuits/code for described algorithms, specific firmware code, specific interconnect operation, specific logic configurations, specific manufacturing techniques and materials, specific compiler implementations, specific expression of algorithms in code, specific power down and gating techniques/logic and other specific operational details of computer system have not been described in detail in order to avoid unnecessarily obscuring the present invention.

Although the following embodiments are described with reference to a processor, other embodiments are applicable to other types of integrated circuits and logic devices. Similar techniques and teachings of embodiments of the present invention can be applied to other types of circuits or semiconductor devices that can benefit from higher pipeline throughput and improved performance. The teachings of embodiments of the present invention are applicable to any processor or machine that performs data manipulations. However, the present invention is not limited to processors or machines that perform 512 bit, 256 bit, 128 bit, 64 bit, 32 bit, or 16 bit data operations and can be applied to any processor and machine in which manipulation or management of data is performed. In addition, the following description provides examples, and the accompanying drawings show various examples for the purposes of illustration. However, these examples should not be construed in a limiting sense as they are merely intended to provide examples of embodiments of the present invention rather than to provide an exhaustive list of all possible implementations of embodiments of the present invention.

Although the below examples describe instruction handling and distribution in the context of execution units and logic circuits, other embodiments of the present invention can be accomplished by way of a data or instructions stored on a machine-readable, tangible medium, which when performed by a machine cause the machine to perform functions consistent with at least one embodiment of the invention. In one embodiment, functions associated with embodiments of the present invention are embodied in machine-executable instructions. The instructions can be used to cause a general-purpose or special-purpose processor that is programmed with the instructions to perform the steps of the present invention. Embodiments of the present invention may be provided as a computer program product or software which may include a machine or computer-readable medium having stored thereon instructions which may be used to program a computer (or other electronic devices) to perform one or more operations according to embodiments of the present invention. Alternatively, operations of embodiments of the present invention might be performed by specific hardware components that contain fixed-function logic for performing the operations, or by any combination of programmed computer components and fixed-function hardware components.

Instructions used to program logic to perform embodiments of the invention can be stored within a memory in the system, such as DRAM, cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the computer-readable medium includes any type of tangible machine-readable medium suitable for storing or transmitting electronic instructions or information in a form readable by a machine (e.g., a computer).

“Processor” herein shall refer to a device capable of executing instructions encoding arithmetic, logical, or I/O operations. In one illustrative example, a processor may follow Von Neumann architectural model and may include an arithmetic logic unit (ALU), a control unit, and a plurality of registers. In a further aspect, a processor may include one or more processor cores, and hence may be a single core processor which is typically capable of processing a single instruction pipeline, or a multi-core processor which may simultaneously process multiple instruction pipelines. In another aspect, a processor may be implemented as a single integrated circuit, two or more integrated circuits, or may be a component of a multi-chip module (e.g., in which individual microprocessor dies are included in a single integrated circuit package and hence share a single socket).

FIG. 1 depicts a high-level component diagram of one example of a computer system in accordance with one or more aspects of the present disclosure. A computer system 100 may include a processor 102 to employ execution units including logic to perform algorithms for processing data, in accordance with the embodiment described herein. System 100 is representative of processing systems based on the PENTIUM III™, PENTIUM 4™, Xeon™, Itanium, XScale™ and/or StrongARM™ microprocessors available from Intel Corporation of Santa Clara, Calif., although other systems (including PCs having other microprocessors, engineering workstations, set-top boxes and the like) may also be used. In one embodiment, sample system 100 executes a version of the WINDOWS™ operating system available from Microsoft Corporation of Redmond, Wash., although other operating systems (UNIX and Linux for example), embedded software, and/or graphical user interfaces, may also be used. Thus, embodiments of the present invention are not limited to any specific combination of hardware circuitry and software.

Embodiments are not limited to computer systems. Alternative embodiments of the present invention can be used in other devices such as handheld devices and embedded applications. Some examples of handheld devices include cellular phones, Internet Protocol devices, digital cameras, personal digital assistants (PDAs), and handheld PCs. Embedded applications can include a micro controller, a digital signal processor (DSP), system on a chip, network computers (NetPC), set-top boxes, network hubs, wide area network (WAN) switches, or any other system that can perform one or more instructions in accordance with at least one embodiment.

In this illustrated example, processor 102 includes one or more execution units 108 to implement an algorithm that is to perform one or more instructions, e.g., transactional memory access instructions. One embodiment may be described in the context of a single processor desktop or server system, but alternative embodiments may be included in a multiprocessor system. System 100 is an example of a ‘hub’ system architecture. The computer system 100 includes a processor 102 to process data signals. The processor 102, as one illustrative example, includes a complex instruction set computer (CISC) microprocessor, a reduced instruction set computing (RISC) microprocessor, a very long instruction word (VLIW) microprocessor, a processor implementing a combination of instruction sets, or any other processor device, such as a digital signal processor, for example. The processor 102 is coupled to a processor bus 110 that transmits data signals between the processor 102 and other components in the system 100. The elements of system 100 (e.g. graphics accelerator 112, memory controller hub 116, memory 120, I/O controller hub 124, wireless transceiver 126, Flash BIOS 128, Network controller 134, Audio controller 136, Serial expansion port 138, I/O controller 140, etc.) perform their conventional functions that are well known to those familiar with the art.

In one embodiment, the processor 102 includes a Level 1 (L1) internal cache 104. Depending on the architecture, the processor 102 may have a single internal cache or multiple levels of internal caches. Other embodiments include a combination of both internal and external caches depending on the particular implementation and needs. Register file 106 is to store different types of data in various registers including integer registers, floating point registers, vector registers, banked registers, shadow registers, checkpoint registers, status registers, and instruction pointer register.

Execution unit 108, including logic to perform integer and floating point operations, also resides in the processor 102. The processor 102, in one embodiment, includes a microcode (ucode) ROM to store microcode, which when executed, is to perform algorithms for certain macroinstructions or handle complex scenarios. Here, microcode is potentially updateable to handle logic bugs/fixes for processor 102. For one embodiment, execution unit 108 includes logic to handle a packed instruction set 109. By including the packed instruction set 109 in the instruction set of a general-purpose processor 102, along with associated circuitry to execute the instructions, the operations used by many multimedia applications may be performed using packed data in a general-purpose processor 102. Thus, many multimedia applications are accelerated and executed more efficiently by using the full width of a processor's data bus for performing operations on packed data. This potentially eliminates the need to transfer smaller units of data across the processor's data bus to perform one or more operations, one data element at a time.

In other examples, an execution unit 108 may also be used in micro controllers, embedded processors, graphics devices, DSPs, and other types of logic circuits. System 100 includes a memory 120. Memory 120 includes a dynamic random access memory (DRAM) device, a static random access memory (SRAM) device, flash memory device, or other memory device. Memory 120 stores instructions and/or data represented by data signals that are to be executed by the processor 102.

A system logic chip 116 is coupled to the processor bus 110 and memory 120. The system logic chip 116 in the illustrated embodiment is a memory controller hub (MCH). The processor 102 can communicate to the MCH 116 via a processor bus 110. The MCH 116 provides a high bandwidth memory path 118 to memory 120 for instruction and data storage and for storage of graphics commands, data and textures. The MCH 116 is to direct data signals between the processor 102, memory 120, and other components in the system 100 and to bridge the data signals between processor bus 110, memory 120, and system I/O 122. In some embodiments, the system logic chip 116 can provide a graphics port for coupling to a graphics controller 112. The MCH 116 is coupled to memory 120 through a memory interface 118. The graphics card 112 is coupled to the MCH 116 through an Accelerated Graphics Port (AGP) interconnect 114.

System 100 uses a proprietary hub interface bus 122 to couple the MCH 116 to the I/O controller hub (ICH) 130. The ICH 130 provides direct connections to some I/O devices via a local I/O bus. The local I/O bus is a high-speed I/O bus for connecting peripherals to the memory 120, chipset, and processor 102. Some examples are the audio controller, firmware hub (flash BIOS) 128, wireless transceiver 126, data storage 124, legacy I/O controller containing user input and keyboard interfaces, a serial expansion port such as Universal Serial Bus (USB), and a network controller 134. The data storage device 124 can comprise a hard disk drive, a floppy disk drive, a CD-ROM device, a flash memory device, or other mass storage device.

In another example of a system, an instruction in accordance with one embodiment can be used with a system on a chip. One embodiment of a system on a chip comprises of a processor and a memory. The memory for one such system is a flash memory. The flash memory can be located on the same die as the processor and other system components. Additionally, other logic blocks such as a memory controller or graphics controller can also be located on a system on a chip.

Processor 102 of the above examples may be capable of executing transactional memory access. In certain implementations, the processor 102 may be also capable of executing one or more memory read and/or write operations which may be immediately committed such that their results immediately become visible to other devices (e.g., other processor cores or other processors), irrespectively of the transaction successful completion or aborting, as described in more details herein below.

FIG. 2 is a block diagram of the micro-architecture for a processor 200 that includes logic circuits to perform transactional memory access instructions and/or non-transactional memory access instructions in accordance with one embodiment of the present invention. In some embodiments, an instruction in accordance with one embodiment can be implemented to operate on data elements having sizes of byte, word, doubleword, quadword, etc., as well as datatypes, such as single and double precision integer and floating point datatypes. In one embodiment the in-order front end 201 is the part of the processor 200 that fetches instructions to be executed and prepares them to be used later in the processor pipeline. The front end 201 may include several units. In one embodiment, the instruction prefetcher 226 fetches instructions from memory and feeds them to an instruction decoder 228 which in turn decodes or interprets them. For example, in one embodiment, the decoder decodes a received instruction into one or more operations called “micro-instructions” or “micro-operations” (also called micro op or uops) that the machine can execute. In other embodiments, the decoder parses the instruction into an opcode and corresponding data and control fields that are used by the micro-architecture to perform operations in accordance with one embodiment. In one embodiment, the trace cache 230 takes decoded uops and assembles them into program ordered sequences or traces in the uop queue 234 for execution. When the trace cache 230 encounters a complex instruction, the microcode ROM 232 provides the uops needed to complete the operation.

Some instructions are converted into a single micro-op, whereas others need several micro-ops to complete the full operation. In one embodiment, if more than four micro-ops are needed to complete an instruction, the decoder 228 accesses the microcode ROM 232 to do the instruction. For one embodiment, an instruction can be decoded into a small number of micro ops for processing at the instruction decoder 228. In another embodiment, an instruction can be stored within the microcode ROM 232 should a number of micro-ops be needed to accomplish the operation. The trace cache 230 refers to an entry point programmable logic array (PLA) to determine a correct micro-instruction pointer for reading the micro-code sequences to complete one or more instructions in accordance with one embodiment from the micro-code ROM 232. After the microcode ROM 232 finishes sequencing micro-ops for an instruction, the front end 201 of the machine resumes fetching micro-ops from the trace cache 230.

The out-of-order execution engine 203 is where the instructions are prepared for execution. The out-of-order execution logic has a number of buffers to smooth out and re-order the flow of instructions to optimize performance as they go down the pipeline and get scheduled for execution. The allocator logic allocates the machine buffers and resources that each uop needs in order to execute. The register renaming logic renames logic registers onto entries in a register file. The allocator also allocates an entry for each uop in one of the two uop queues, one for memory operations and one for non-memory operations, in front of the instruction schedulers: memory scheduler, fast scheduler 202, slow/general floating point scheduler 204, and simple floating point scheduler 206. The uop schedulers 202, 204, 206 determine when a uop is ready to execute based on the readiness of their dependent input register operand sources and the availability of the execution resources the uops need to complete their operation. The fast scheduler 202 of one embodiment can schedule on each half of the main clock cycle while the other schedulers can schedule once per main processor clock cycle. The schedulers arbitrate for the dispatch ports to schedule uops for execution.

Register files 208, 210 sit between the schedulers 202, 204, 206, and the execution units 212, 214, 216, 218, 220, 222, 224 in the execution block 211. There is a separate register file 208, 210 for integer and floating point operations, respectively. Each register file 208, 210, of one embodiment also includes a bypass network that can bypass or forward just completed results that have not yet been written into the register file to new dependent uops. The integer register file 208 and the floating point register file 210 are also capable of communicating data with the other. For one embodiment, the integer register file 208 is split into two separate register files, one register file for the low order 32 bits of data and a second register file for the high order 32 bits of data. The floating point register file 210 of one embodiment has 128 bit wide entries because floating point instructions typically have operands from 64 to 128 bits in width.

The execution block 211 contains the execution units 212, 214, 216, 218, 220, 222, 224, where the instructions are actually executed. This section includes the register files 208, 210, that store the integer and floating point data operand values that the micro-instructions need to execute. The processor 200 of one embodiment is comprised of a number of execution units: address generation unit (AGU) 212, AGU 214, fast ALU 216, fast ALU 218, slow ALU 220, floating point ALU 222, floating point move unit 224. For one embodiment, the floating point execution blocks 222, 224, execute floating point, MMX, SIMD, and SSE, or other operations. The floating point ALU 222 of one embodiment includes a 64 bit by 64 bit floating point divider to execute divide, square root, and remainder micro-ops. For embodiments of the present invention, instructions involving a floating point value may be handled with the floating point hardware. In one embodiment, the ALU operations go to the high-speed ALU execution units 216, 218. The fast ALUs 216, 218, of one embodiment can execute fast operations with an effective latency of half a clock cycle. For one embodiment, most complex integer operations go to the slow ALU 220 as the slow ALU 220 includes integer execution hardware for long latency type of operations, such as a multiplier, shifts, flag logic, and branch processing. Memory load/store operations are executed by the AGUs 212, 214. For one embodiment, the integer ALUs 216, 218, 220 are described in the context of performing integer operations on 64 bit data operands. In alternative embodiments, the ALUs 216, 218, 220 can be implemented to support a variety of data bits including 16, 32, 128, 256, etc. Similarly, the floating point units 222, 224 can be implemented to support a range of operands having bits of various widths. For one embodiment, the floating point units 222, 224 can operate on 128 bits wide packed data operands in conjunction with SIMD and multimedia instructions.

In one embodiment, the uops schedulers 202, 204, 206 dispatch dependent operations before the parent load has finished executing. As uops are speculatively scheduled and executed in processor 200, the processor 200 also includes logic to handle memory misses. If a data load misses in the data cache, there can be dependent operations in flight in the pipeline that have left the scheduler with temporarily incorrect data. A replay mechanism tracks and re-executes instructions that use incorrect data. The dependent operations should be replayed and the independent ones are allowed to complete. The schedulers and replay mechanism of one embodiment of a processor are also designed to catch instruction sequences for text string comparison operations.

The term “registers” may refer to the on-board processor storage locations that are used as part of instructions to identify operands. In other words, registers may be those that are usable from the outside of the processor (from a programmer's perspective). However, the registers of an embodiment should not be limited in meaning to a particular type of circuit. Rather, a register of an embodiment is capable of storing and providing data, and performing the functions described herein. The registers described herein can be implemented by circuitry within a processor using any number of different techniques, such as dedicated physical registers, dynamically allocated physical registers using register renaming, combinations of dedicated and dynamically allocated physical registers, etc. In one embodiment, integer registers store thirty-two bit integer data. A register file of one embodiment also contains eight multimedia SIMD registers for packed data. For the discussions below, the registers are understood to be data registers designed to hold packed data, such as 64 bits wide MMX registers (also referred to as ‘mm’ registers in some instances) in microprocessors enabled with the MMX™ technology from Intel Corporation of Santa Clara, Calif. These MMX registers, available in both integer and floating point forms, can operate with packed data elements that accompany SIMD and SSE instructions. Similarly, 128 bits wide XMM registers relating to SSE2, SSE3, SSE4, or beyond (referred to generically as “SSEx”) technology can also be used to hold such packed data operands. In one embodiment, in storing packed data and integer data, the registers do not need to differentiate between the two data types. In one embodiment, integer and floating point are either contained in the same register file or different register files. Furthermore, in one embodiment, floating point and integer data may be stored in different registers or the same registers.

FIGS. 3a-3b schematically illustrate elements of a processor micro-architecture, in accordance with one or more aspects of the present disclosure. In FIG. 3a, a processor pipeline 400 includes a fetch stage 402, a length decode stage 404, a decode stage 406, an allocation stage 408, a renaming stage 410, a scheduling (also known as a dispatch or issue) stage 412, a register read/memory read stage 414, an execute stage 416, a write back/memory write stage 418, an exception handling stage 422, and a commit stage 424.

In FIG. 3b, arrows denote a coupling between two or more units and the direction of the arrow indicates a direction of data flow between those units. FIG. 3b shows processor core 490 including a front end unit 430 coupled to an execution engine unit 450, and both are coupled to a memory unit 470.

The core 490 may be a reduced instruction set computing (RISC) core, a complex instruction set computing (CISC) core, a very long instruction word (VLIW) core, or a hybrid or alternative core type. As yet another option, the core 490 may be a special-purpose core, such as, for example, a network or communication core, compression engine, graphics core, or the like. In certain implementations, the core 490 may be capable of executing transactional memory access instructions and/or non-transactional memory access instructions, in accordance with one or more aspects of the present disclosure.

The front end unit 430 includes a branch prediction unit 432 coupled to an instruction cache unit 434, which is coupled to an instruction translation lookaside buffer (TLB) 436, which is coupled to an instruction fetch unit 438, which is coupled to a decode unit 440. The decode unit or decoder may decode instructions, and generate as an output one or more micro-operations, micro-code entry points, microinstructions, other instructions, or other control signals, which are decoded from, or which otherwise reflect, or are derived from, the original instructions. The decoder may be implemented using various different mechanisms. Examples of suitable mechanisms include, but are not limited to, look-up tables, hardware implementations, programmable logic arrays (PLAs), microcode read only memories (ROMs), etc. The instruction cache unit 434 is further coupled to a level 2 (L2) cache unit 476 in the memory unit 470. The decode unit 440 is coupled to a rename/allocator unit 452 in the execution engine unit 450.

The execution engine unit 450 includes the rename/allocator unit 452 coupled to a retirement unit 454 and a set of one or more scheduler unit(s) 456. The scheduler unit(s) 456 represents any number of different schedulers, including reservations stations, central instruction window, etc. The scheduler unit(s) 456 is coupled to the physical register file(s) unit(s) 458. Each of the physical register file(s) units 458 represents one or more physical register files, different ones of which store one or more different data types, such as scalar integer, scalar floating point, packed integer, packed floating point, vector integer, vector floating point, etc., status (e.g., an instruction pointer that is the address of the next instruction to be executed), etc. The physical register file(s) unit(s) 458 is overlapped by the retirement unit 454 to illustrate various ways in which register aliasing and out-of-order execution may be implemented (e.g., using a reorder buffer(s) and a retirement register file(s), using a future file(s), a history buffer(s), and a retirement register file(s); using a register maps and a pool of registers; etc.). Generally, the architectural registers are visible from the outside of the processor or from a programmer's perspective. The registers are not limited to any known particular type of circuit. Various different types of registers are suitable as long as they are capable of storing and providing data as described herein. Examples of suitable registers include, but are not limited to, dedicated physical registers, dynamically allocated physical registers using register aliasing, combinations of dedicated and dynamically allocated physical registers, etc. The retirement unit 454 and the physical register file(s) unit(s) 458 are coupled to the execution cluster(s) 460. The execution cluster(s) 460 includes a set of one or more execution units 162 and a set of one or more memory access units 464. The execution units 462 may perform various operations (e.g., shifts, addition, subtraction, multiplication) and on various types of data (e.g., scalar floating point, packed integer, packed floating point, vector integer, vector floating point). While some embodiments may include a number of execution units dedicated to specific functions or sets of functions, other embodiments may include one execution unit or multiple execution units that all perform all functions. The scheduler unit(s) 456, physical register file(s) unit(s) 458, and execution cluster(s) 460 are shown as being possibly plural because certain embodiments create separate pipelines for certain types of data/operations (e.g., a scalar integer pipeline, a scalar floating point/packed integer/packed floating point/vector integer/vector floating point pipeline, and/or a memory access pipeline that each have their own scheduler unit, physical register file(s) unit, and/or execution cluster—and in the case of a separate memory access pipeline, certain embodiments are implemented in which the execution cluster of this pipeline has the memory access unit(s) 464). It should also be understood that where separate pipelines are used, one or more of these pipelines may be out-of-order issue/execution and the rest in-order.

The set of memory access units 464 is coupled to the memory unit 470, which includes a data TLB unit 472 coupled to a data cache unit 474 coupled to a level 2 (L2) cache unit 476. In one exemplary embodiment, the memory access units 464 may include a load unit, a store address unit, and a store data unit, each of which is coupled to the data TLB unit 472 in the memory unit 470. The L2 cache unit 476 is coupled to one or more other levels of cache and eventually to a main memory.

By way of example, the out-of-order issue/execution core architecture may implement the pipeline 400 as follows: the instruction fetch 438 performs the fetch and length decoding stages 402 and 404; the decode unit 440 performs the decode stage 406; the rename/allocator unit 452 performs the allocation stage 408 and renaming stage 410; the scheduler unit(s) 456 performs the schedule stage 412; the physical register file(s) unit(s) 458 and the memory unit 470 perform the register read/memory read stage 414; the execution cluster 460 perform the execute stage 416; the memory unit 470 and the physical register file(s) unit(s) 458 perform the write back/memory write stage 418; various units may be involved in the exception handling stage 422; and the retirement unit 454 and the physical register file(s) unit(s) 458 perform the commit stage 424.

The core 490 may support one or more instructions sets (e.g., the x86 instruction set (with some extensions that have been added with newer versions); the MIPS instruction set of MIPS Technologies of Sunnyvale, Calif.; the ARM instruction set (with additional extensions such as NEON) of ARM Holdings of Sunnyvale, Calif.).

In certain implementations, the core may support multithreading (executing two or more parallel sets of operations or threads), and may do so in a variety of ways including time sliced multithreading, simultaneous multithreading (where a single physical core provides a logical core for each of the threads that physical core is simultaneously multithreading), or a combination thereof (e.g., time sliced fetching and decoding and simultaneous multithreading thereafter such as in the Intel® Hyperthreading technology).

While the illustrated embodiment of the processor also includes a separate instruction and data cache units 434/474 and a shared L2 cache unit 476, alternative embodiments may have a single internal cache for both instructions and data, such as, for example, a Level 1 (L1) internal cache, or multiple levels of internal cache. In some embodiments, the system may include a combination of an internal cache and an external cache that is external to the core and/or the processor. Alternatively, all of the cache may be external to the core and/or the processor.

FIG. 4 schematically illustrates several aspects of a computer system 100 in accordance with one or more aspects of the present disclosure. As noted herein above and schematically illustrated by FIG. 4, the processor 102 may comprise one or more caches 104 for storing instructions and/or data, including, for example, an L1 cache and an L2 cache. The cache 104 may be accessible by one or more processor cores 123. In certain implementations, the cache 104 may be represented by a write-through cache, in which every cache write operation causes a write operation to the system memory 120. Alternatively, the cache 104 may be represented by a write-back cache, in which cache write operations are not immediately mirrored to the system memory 120. In certain implementations, the cache 104 may implement a cache coherency protocol, such as, for example, Modified-Exclusive-Shared-Invalid (MESI) protocol, to provide consistency of data stored in one or more caches with respect to a shared memory.

In certain implementations, the processor 102 may further comprise one or more read buffers 127 and one or more write buffers 129 to hold data read from/written into memory 120. The buffers may be of the same or several fixed sizes, or may have variable sizes. In one example, the read buffers and the write buffers may be represented by the same plurality of buffers. In one example, the read buffers and/or the write buffers may be represented by a plurality of cache entries of the cache 104.

The processor 102 may further comprise a memory tracking logic 131 associated with the buffers 127 and 129. The memory tracking logic may comprise circuitry configured to track access to memory locations (identified, e.g., by physical addresses) which have previously been buffered to the buffers 127 and/or 129, thus providing coherency of data stored by the buffers 127 and/or 129 with respect to the corresponding memory locations. In certain implementations, the buffers 127 and/or 129 may have address tags associated with them, to hold addresses of the memory locations being buffered. The circuitry implementing the memory tracking logic 131 may be communicatively coupled to the address bus of the computer system 100, and hence may implement snooping, by reading the addresses specified by other devices (e.g., other processors or direct memory access (DMA) controllers) on the address bus, and comparing those addresses with the addresses identifying memory locations which have previously been buffered to the buffers 127 and/or 129.

The processor 102 may further comprise an error recovery routine address register 135 to hold an address of an error recovery routine to be executed in the event of abnormal transaction termination, as described in more details herein below. The processor 102 may further comprise a transaction status register 137 to hold a transaction error code, as described in more details herein below.

In order to allow the processor 102 implement transactional memory access, its instruction set may include a transaction start (TX_START) instruction and a transaction end (TX_END) instruction. The TX_START instruction may comprise one or more operands including the address of an error recovery routine to be executed by the processor 102 if the transaction terminates abnormally, and/or the number of hardware buffers required for performing the transaction.

In certain implementations, the transaction start instruction may cause the processor to allocate the read and/or write buffers for executing the transaction. In certain implementations, the transaction start instruction may further cause the processor to commit all pending store operations to assure that results of previously executed memory access operations become visible to other devices accessing the same memory. In certain implementations, the transaction start instruction may further cause the processor to stop data prefetching. In certain implementations, the transaction start instruction may further cause the processor to disable interrupts for a defined number of cycles in order to improve the chances of transaction to succeed (since an interrupt occurring while transaction is pending may invalidate the transaction).

Responsive to processing a TX_START instruction, the processor 102 may enter the transactional mode of operation which may be terminated by a corresponding TX_END instruction or by detecting an error condition. In the transactional mode of operation, the processor 102 may speculatively (i.e., without acquiring a lock with respect to the memory being accessed) perform a plurality of memory read and/or memory write operations via the respective read buffers 127 and/or write buffers 129.

In the transactional mode of operation, the processor may allocate a read buffer 127 for each load acquire operation (an existing buffer may be re-used if it already holds the content of the memory location being accessed; otherwise, a new buffer may be allocated). The processor may further allocate a write buffer 129 for each store acquire operation (an existing buffer may be re-used if it already holds the content of the memory location being accessed; otherwise, a new buffer may be allocated). The write buffers 129 may hold results of write operations without committing the data to the corresponding memory locations. The memory tracking logic 131 may detect other device's access to the specified memory locations, and signal the error condition to the processor 102. Responsive to receiving the error signal, the processor 102 may abort the transaction and transfer the control to the error recovery routine specified by the corresponding TX_START instruction. Otherwise, responsive to receiving a TX_END instruction, the processor 102 may commit the write operations to the corresponding memory or cache locations.

In the transactional mode of operation, the processor may also execute one or more memory read and/or write operations which may be immediately committed such that their results immediately become visible to other devices (e.g., other processor cores or other processors), irrespectively of the transaction successful completion or aborting. The ability of executing non-transactional memory access within a transaction enhances the programming flexibility of the processor and may further improve the execution efficiency.

The read buffers 127 and/or write buffers 129 may be implemented by allocating a plurality of cache entries in the lowest level data cache of the processor 102. Should a transaction be aborted, the read and/or write buffers may be marked as invalid and/or available. As noted herein above, a transaction may be aborted responsive to detecting access by other device to the memory being read and/or modified during the transactional mode of execution. Other transaction aborting condition may include a hardware interrupt, overflow of hardware buffers, and/or a program error detected during the transactional mode of execution. In certain implementations, status flags, including, e.g., zero flag, carry flag, and/or overflow flag, may be employed to hold status indicating the source of the error detected in the transactional mode of execution. Alternatively, the transaction error code may be stored in the transaction status register 137.

A transaction completes normally if the execution reaches a corresponding TX_END instruction and no data buffered by the buffers 127 and/or 129 has been read or modified. Upon reaching the TX_END instruction, the processor may, responsive to ascertaining that no transaction aborting conditions occurred during the transactional mode of operation, commit the write operation results to the corresponding memory or cache locations, and release the buffers 127 and/or 127 which have previously been allocated for the transaction. In certain implementations, the processor 102 may commit the transactional write operations irrespectively of the state of the memory locations read and/or modified by the non-transactional memory access operations.

If a transaction aborting condition has been detected, the processor may abort the transaction and transfer control to the error recovery routine the address of which may be stored in the error recovery routine address register 135. Should the transaction be aborted, the buffers 127 and/or 129 which have previously been allocated for the transaction, may be marked as invalid and/or available.

In certain implementations, the processor 102 may support nested transactions. A nested transaction may be started by a TX_START instruction executed within the scope of another (outer) transaction. Committing a nested transaction may have no effect on the state of the outer transaction, other than providing visibility within the scope of the outer transaction to the results of the nested transaction; however, those resulted may still be hidden from other devices until the outer transaction also commits.

To implement nested transaction, the TX_END instruction may include an operand indicating the address of the corresponding TX_START instruction. Furthermore, the error recovery routine address register 135 may be expanded to hold an error recovery routine address for several nested transactions which may simultaneously be active.

An error occurring within the scope of a nested transaction may invalidate all outer transactions. Each error recovery routine within a chain of nested transactions may be responsible for invoking the error recovery routine of the corresponding outer transaction.

In certain implementations, the transaction start and transaction end instructions can be used to modify the behavior of load acquire and/or store acquire instructions existing in the processor's set of instructions, by grouping several load acquire and/or store acquire instructions into a sequence of instructions executed in the transactional mode, as described in more details herein above.

An example code fragment illustrating the use of transactional mode instructions is shown in FIG. 5. The code fragment 500 illustrates money transfer between two accounts: an amount stored in EBX is transferred from SrcAccount into DstAccount. The code fragment 200 further illustrates non-transactional memory operations: the contents of SomeStatistic counter is loaded into a register, incremented, and stored back into memory without monitoring the status of the memory being read and modified. The result of the store operation with respect to the address of the SomeStatistic counter is immediately committed and hence becomes immediately visible to all other devices.

FIG. 6 depicts a flow diagram of an example method for transactional memory access, in accordance with one or more aspects of the present disclosure. The method 600 may be performed by a computer system that may comprise hardware (e.g., circuitry, dedicated logic, and/or programmable logic), software (e.g., instructions executable on a computer system to perform hardware simulation), or a combination thereof. The method 600 and/or each of its functions, routines, subroutines, or operations may be performed by one or more physical processors of the computer system executing the method. Two or more functions, routines, subroutines, or operations of method 600 may be performed in parallel by different processors accessing the same memory or in an order which may differ from the order described above. In one example, as illustrated by FIG. 6, the method 600 may be performed by the computer system 100 of FIG. 1, for implementing transactional memory access.

Referring to FIG. 6, at block 610, a processor may initiate a memory access transaction. As noted herein above, a memory access transaction may be initiated by a dedicated transaction start instruction. The transaction start may comprise one or more operands including the address of an error recovery routine to be executed by the processor if the transaction terminates abnormally, and/or the number of hardware buffers required for performing the transaction. In certain implementations, the transaction start instruction may further cause the processor to allocate the read and/or write buffers for executing the transaction. In certain implementations, the transaction start instruction may further cause the processor to commit all pending store operations to assure that results of previously executed memory access operations become visible to other devices accessing the same memory. In certain implementations, the transaction start instruction may further cause the processor to stop data prefetching.

At block 620, the processor may speculatively execute one or more memory read operations via one or more hardware buffers associated with a memory tracking logic. Each memory block to be read may be identified by the starting address and the size, or by the address range. The memory tracking logic may detect access to the specified memory addresses by other devices, and signal the error condition to the processor.

At block 630, the processor may speculatively execute one or more memory write operations via one or more hardware buffers associated with a memory tracking logic. Each memory block to be written to may be identified by the starting address and the size, or by the address range. The write buffers may hold results of memory write operations without committing the data to the corresponding memory locations. The memory tracking logic may detect access to the specified memory addresses by other devices, and signal the error condition to the processor.

Responsive to detecting, as schematically shown by block 640, an error during the memory write operation referenced by bloc 630, the processor may execute, at block 660, the error recovery routine specified by the TX_START instruction; otherwise, the processing may continue at block 670.

At block 670, the processor may execute and immediately commit one or more memory read and/or write operations. As those operations are immediately committed, their results immediately become visible to other devices (e.g., other processor cores or other processors), irrespectively of the transaction successful completion or aborting.

Upon reaching a transaction end instruction, the processor may ascertain that no transaction aborting conditions occurred during the transactional mode of operation, as schematically shown by block 670. Responsive to detecting, at block 670, an error during the transactional mode of operation initiated at block 610, the processor may execute, the error recovery routine, as schematically shown by block 660; otherwise, the processor may, as schematically shown by block 680, complete the transaction, irrespectively of the state of the memory locations read and/or modified by the non-transactional memory access operations referenced by block 670. The processor may commit the write operation results to the corresponding memory or cache locations, and release the buffers which have previously been allocated for the transaction. Upon completing the operations referenced by block 670, the method may terminate.

In certain implementations, transaction errors may also be detected during execution of several instructions (such as load or store instructions) in the transactional mode of operation. In FIG. 6, the dashed lines originating from blocks 620 and 630 schematically illustrate branching to the error recovery routine from several instructions executed in the transactional mode of operation.

In certain implementations, transaction errors may also be detected during the execution of the transaction end instruction (e.g., if there are delays in the logic reporting access to the transactional memory by other devices). In FIG. 6, the dashed line originating from block 680 schematically illustrates branching to the error recovery routine from the transaction end instruction.

FIG. 7 depicts a block diagram of an example computer system, in accordance with one or more aspects of the present disclosure. As shown in FIG. 7, multiprocessor system 700 is a point-to-point interconnect system, and includes a first processor 770 and a second processor 780 coupled via a point-to-point interconnect 750. Each of processors 770 and 780 may be some version of the processor 102 capable of executing transactional memory access operations and/or non-transactional memory access operations, as described in more details herein above.

While shown with only two processors 770, 780, it is to be understood that the scope of the present invention is not so limited. In other embodiments, one or more additional processors may be present in a given processor.

Processors 770 and 780 are shown including integrated memory controller units 772 and 782, respectively. Processor 770 also includes as part of its bus controller units point-to-point (P-P) interfaces 776 and 778; similarly, second processor 780 includes P-P interfaces 786 and 788. Processors 770, 780 may exchange information via a point-to-point (P-P) interface 750 using P-P interface circuits 778, 788. As shown in FIG. 7, IMCs 772 and 782 couple the processors to respective memories, namely a memory 732 and a memory 734, which may be portions of main memory locally attached to the respective processors.

Processors 770, 780 may each exchange information with a chipset 790 via individual P-P interfaces 752, 754 using point to point interface circuits 776, 794, 786, 798. Chipset 790 may also exchange information with a high-performance graphics circuit 738 via a high-performance graphics interface 739.

A shared cache (not shown) may be included in either processor or outside of both processors, yet connected with the processors via P-P interconnect, such that either or both processors' local cache information may be stored in the shared cache if a processor is placed into a low power mode.

Chipset 790 may be coupled to a first bus 716 via an interface 796. In one embodiment, first bus 716 may be a Peripheral Component Interconnect (PCI) bus, or a bus such as a PCI Express bus or another third generation I/O interconnect bus, although the scope of the present invention is not so limited.

As shown in FIG. 7, various I/O devices 714 may be coupled to first bus 716, along with a bus bridge 718 which couples first bus 716 to a second bus 720. In one embodiment, second bus 720 may be a low pin count (LPC) bus. Various devices may be coupled to second bus 720 including, for example, a keyboard and/or mouse 722, communication devices 727 and a storage unit 728 such as a disk drive or other mass storage device which may include instructions/code and data 730, in one embodiment. Further, an audio I/O 724 may be coupled to second bus 720. Note that other architectures are possible. For example, instead of the point-to-point architecture of FIG. 7, a system may implement a multi-drop bus or other such architecture.

The following examples illustrate various implementations in accordance with one or more aspect of the present disclosure.

Example 1 is a method for transactional memory access, comprising: initiating, by a processor, a memory access transaction; executing at least one of: a transactional read operation, using a first buffer associated with a memory access tracking logic, with respect to a first memory location, or a transactional write operation, using a second buffer associated with the memory access tracking logic, with respect to a second memory location; executing at least one of: a non-transactional read operation with respect to a third memory location, or a non-transactional write operation with respect to a fourth memory location; responsive to detecting, by the memory access tracking logic, access by a device other than the processor to at least one of the first memory location or the second memory location, aborting the memory access transaction; and responsive to failing to detect a transaction aborting condition and irrespectively of a state of the third memory location and a state of the fourth memory location, completing the memory access transaction.

In example 2, the first buffer and the second buffer of the method of Example 1 may be represented by one buffer.

In example 3, the first memory location and the second memory location of the method of Example 1 may be represented by one memory location.

In example 4, the third memory location and the fourth memory location of the method of Example 1 may be represented by one memory location.

In example 5, at least one of the first buffer or the second buffer of the method of Example 1 may be provided by an entry in a data cache.

In Example 6, the executing operation of the method of any of the Examples 1-6 may comprise committing the second write operation.

In Example 7, the completing operation of the method of any of the Examples 1-6 may comprise copying data from the second buffer into one of: a higher level cache entry or a memory location.

In Example 8, the method of any of the Examples 1-6 may further comprise aborting the memory access transaction responsive to detecting at least one of: an interrupt, a buffer overflow, or a program error.

In Example 9, the aborting operation of the method of any of the Examples 1-6 may comprise releasing at least one of the first buffer and the second buffer.

In Example 10, the initiating operation of the method of any of the Examples 1-6 may comprise committing a pending write operation.

In Example 11, the initiating operation of the method of any of the Examples 1-6 may comprise disabling interrupts.

In Example 12, the initiating operation of the method of any of the Examples 1-6 may comprise disabling data pre-fetching.

In Example 13, the method of any of the Examples 1-6 may further comprise: initiating, before completing the memory access transaction, a nested memory access transaction; executing at least one of: a second transactional read operation, using a third buffer associated with the memory access tracking logic, or a second transactional write operation, using a fourth buffer associated with the memory access tracking logic; and completing the nested memory access transaction.

In Example 14, the method of Example 13 may further comprise aborting the memory access transaction and the nested memory access transaction responsive to detecting a transaction aborting condition.

Example 15 is a processing system, comprising: a memory access tracking logic; a first buffer associated with the memory access tracking logic; a second buffer associated with the memory access tracking logic; a processor core communicatively coupled to the first buffer and the second buffer, the processor core configured to perform operations comprising: initiating a memory access transaction; executing at least one of: a transactional read operation, using the first buffer, with respect to a first memory location, or a transactional write operation, using a second buffer, with respect to a second memory location; executing at least one of: a non-transactional read operation with respect to a third memory location, or a non-transactional write operation with respect to a fourth memory location; responsive to detecting, by the memory access tracking logic, access by a device other than the processor to at least one of the first memory location or the second memory location, aborting the memory access transaction; and responsive to failing to detect a transaction aborting condition and irrespectively of a state of the third memory location and a state of the fourth memory location, completing the memory access transaction.

Example 16 is a processing system, comprising: a memory access tracking means; a first buffer associated with the memory access tracking means; a second buffer associated with the memory access tracking means; a processor core communicatively coupled to the first buffer and the second buffer, the processor core configured to perform operations comprising: initiating a memory access transaction; executing at least one of: a transactional read operation, using the first buffer, with respect to a first memory location, or a transactional write operation, using a second buffer, with respect to a second memory location; executing at least one of: a non-transactional read operation with respect to a third memory location, or a non-transactional write operation with respect to a fourth memory location; responsive to detecting, by the memory access tracking means, access by a device other than the processor to at least one of the first memory location or the second memory location, aborting the memory access transaction; and responsive to failing to detect a transaction aborting condition and irrespectively of a state of the third memory location and a state of the fourth memory location, completing the memory access transaction.

In Example 17, the processing system of any of the Examples 15-16 may further comprise a data cache, and at least one of the first buffer and the second buffer may reside in the data cache.

In Example 18, the processing system of any of the Examples 15-16 may further comprise a register to store an address of an error recovery routine.

In Example 19, the processing system of any of the Examples 15-16 may further comprise a register to store a state of the memory access transaction.

In Example 20, the first buffer and the second buffer of the processing system of any of the Examples 15-16 may be represented by one buffer.

In Example 21, the third buffer and the fourth buffer of the processing system of any of the Examples 15-16 may be represented by one buffer.

In example 22, the first memory location and the second memory location of the processing system of any of the Examples 15-16 may be represented by one memory location.

In example 23, the third memory location and the fourth memory location of the processing system of any of the Examples 15-16 may be represented by one memory location.

In Example 24, the processor core of the processing system of any of the Examples 15-16 may be further configured to abort the memory access transaction responsive to detecting at least one of: an interrupt, a buffer overflow, or a program error.

In Example 25, the processor core of the processing system of the Example 15 may be further configured to: initiate, before completing the memory access transaction, a nested memory access transaction; execute at least one of: a second transactional read operation, using a third buffer associated with the memory access tracking logic, or a second transactional write operation, using a fourth buffer associated with the memory access tracking logic; and complete the nested memory access transaction.

In Example 26, the processor core of the processing system of the Example 16 may be further configured to: initiate, before completing the memory access transaction, a nested memory access transaction; execute at least one of: a second transactional read operation, using a third buffer associated with the memory access tracking means, or a second transactional write operation, using a fourth buffer associated with the memory access tracking means; and complete the nested memory access transaction.

In Example 27, the processor core of the processing system of any of the Examples 25-26 may be further configured to abort the memory access transaction and the nested memory access transaction responsive to detecting a transaction aborting condition.

Example 28 is an apparatus comprising a memory and a processing system coupled to the memory, wherein the processing system is configured to perform the method of any of the examples 1-14.

Example 29 is a computer-readable non-transitory storage medium comprising executable instructions that, when executed by a processor, cause the processor to: initiate, by a processor, a memory access transaction; execute at least one of: a transactional read operation, using a first buffer associated with a memory access tracking logic, with respect to a first memory location, or a transactional write operation, using a second buffer associated with the memory access tracking logic, with respect to a second memory location; execute at least one of: a non-transactional read operation with respect to a third memory location, or a non-transactional write operation with respect to a fourth memory location; responsive to detecting, by the memory access tracking logic, access by a device other than the processor to at least one of the first memory location or the second memory location, aborting the memory access transaction; and responsive to failing to detect a transaction aborting condition and irrespectively of a state of the third memory location and a state of the fourth memory location, complete the memory access transaction.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared and otherwise manipulated. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “encrypting,” “decrypting,” “storing,” “providing,” “deriving,” “obtaining,” “receiving,” “authenticating,” “deleting,” “executing,” “requesting,” “communicating,” or the like, refer to the actions and processes of a computing system, or similar electronic computing device, that manipulates and transforms data represented as physical (e.g., electronic) quantities within the computing system's registers and memories into other data similarly represented as physical quantities within the computing system memories or registers or other such information storage, transmission or display devices.

The words “example” or “exemplary” are used herein to mean serving as an example, instance or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such. Also, the terms “first,” “second,” “third,” “fourth,” etc. as used herein are meant as labels to distinguish among different elements and may not necessarily have an ordinal meaning according to their numerical designation.

Embodiments descried herein may also relate to an apparatus for performing the operations herein. This apparatus may be specially constructed for the required purposes, or it may comprise a general-purpose computer selectively activated or reconfigured by a computer program stored in the computer. Such a computer program may be stored in a non-transitory computer-readable storage medium, such as, but not limited to, any type of disk including floppy disks, optical disks, CD-ROMs and magnetic-optical disks, read-only memories (ROMs), random access memories (RAMs), EPROMs, EEPROMs, magnetic or optical cards, flash memory, or any type of media suitable for storing electronic instructions. The term “computer-readable storage medium” should be taken to include a single medium or multiple media (e.g., a centralized or distributed database and/or associated caches and servers) that store the one or more sets of instructions. The term “computer-readable medium” shall also be taken to include any medium that is capable of storing, encoding or carrying a set of instructions for execution by the machine and that causes the machine to perform any one or more of the methodologies of the present embodiments. The term “computer-readable storage medium” shall accordingly be taken to include, but not be limited to, solid-state memories, optical media, magnetic media, any medium that is capable of storing a set of instructions for execution by the machine and that causes the machine to perform any one or more of the methodologies of the present embodiments.

The algorithms and displays presented herein are not inherently related to any particular computer or other apparatus. Various general-purpose systems may be used with programs in accordance with the teachings herein, or it may prove convenient to construct a more specialized apparatus to perform the required method operations. The required structure for a variety of these systems will appear from the description below. In addition, the present embodiments are not described with reference to any particular programming language. It will be appreciated that a variety of programming languages may be used to implement the teachings of the embodiments as described herein.

The above description sets forth numerous specific details such as examples of specific systems, components, methods and so forth, in order to provide a good understanding of several embodiments. It will be apparent to one skilled in the art, however, that at least some embodiments may be practiced without these specific details. In other instances, well-known components or methods are not described in detail or are presented in simple block diagram format in order to avoid unnecessarily obscuring the present embodiments. Thus, the specific details set forth above are merely exemplary. Particular implementations may vary from these exemplary details and still be contemplated to be within the scope of the present embodiments.

It is to be understood that the above description is intended to be illustrative and not restrictive. Many other embodiments will be apparent to those of skill in the art upon reading and understanding the above description. The scope of the present embodiments should, therefore, be determined with reference to the appended claims, along with the full scope of equivalents to which such claims are entitled.

1. A method, comprising:
initiating, by a processor, a memory access transaction;
executing at least one of: a transactional read operation, using a first buffer associated with a memory access tracking logic, with respect to a first memory location, or a transactional write operation, using a second buffer associated with the memory access tracking logic, with respect to a second memory location;
executing at least one of: a non-transactional read operation with respect to a third memory location, or a non-transactional write operation with respect to a fourth memory location;
responsive to detecting, by the memory access tracking logic, access by a device other than the processor to at least one of the first memory location or the second memory location, aborting the memory access transaction; and
responsive to failing to detect a transaction aborting condition and irrespectively of a state of the third memory location and a state of the fourth memory location, completing the memory access transaction.

2. The method of claim 1, wherein the first buffer and the second buffer are represented by one buffer.

3. The method of claim 1, wherein the first memory location and the second memory location are represented by one memory location.

4. The method of claim 1, wherein the third memory location and the fourth memory location are represented by one memory location.

5. The method of claim 1, wherein at least one of the first buffer or the second buffer is provided by an entry in a data cache.

6. The method of claim 1, wherein executing the second write operation comprises committing the second write operation.

7. The method of claim 1, wherein completing the memory access transaction comprises copying data from the second buffer into one of: a higher level cache entry or a memory location.

8. The method of claim 1, further comprising aborting the memory access transaction responsive to detecting at least one of: an interrupt, a buffer overflow, or a program error.

9. The method of claim 1, wherein the aborting comprises releasing at least one of the first buffer and the second buffer.

10. The method of claim 1, wherein initiating the memory access transaction comprises committing a pending write operation.

11. The method of claim 1, wherein initiating the memory access transaction comprises disabling interrupts.

12. The method of claim 1, wherein initiating the memory access transaction comprises disabling data pre-fetching.

13. The method of claim 1, further comprising:
initiating, before completing the memory access transaction, a nested memory access transaction;
executing at least one of: a second transactional read operation, using a third buffer associated with the memory access tracking logic, or a second transactional write operation, using a fourth buffer associated with the memory access tracking logic; and
completing the nested memory access transaction.

14. The method of claim 13, further comprising aborting the memory access transaction and the nested memory access transaction responsive to detecting a transaction aborting condition.

15. A processing system, comprising:
a memory access tracking logic;
a first buffer associated with the memory access tracking logic;
a second buffer associated with the memory access tracking logic;
a processor core communicatively coupled to the first buffer and the second buffer, the processor core configured to perform operations comprising:
initiating a memory access transaction;
executing at least one of: a transactional read operation, using the first buffer, with respect to a first memory location, or a transactional write operation, using a second buffer, with respect to a second memory location;
executing at least one of: a non-transactional read operation with respect to a third memory location, or a non-transactional write operation with respect to a fourth memory location;
responsive to detecting, by the memory access tracking logic, access by a device other than the processor to at least one of the first memory location or the second memory location, aborting the memory access transaction; and
responsive to failing to detect a transaction aborting condition and irrespectively of a state of the third memory location and a state of the fourth memory location, completing the memory access transaction.

16. The processing system of claim 15, further comprising a data cache; wherein at least one of the first buffer or the second buffer reside in the data cache.

17. The processing system of claim 15, further comprising a register to store an address of an error recovery routine.

18. The processing system of claim 15, further comprising a register to store a status of the memory access transaction.

19. The system of claim 15, wherein the first buffer and the second buffer are represented by one buffer.

20. A computer-readable non-transitory storage medium comprising executable instructions that, when executed by a processor, cause the processor to:
initiate a memory access transaction;
execute at least one of: a transactional read operation, using a first buffer associated with a memory access tracking logic, with respect to a first memory location, or a transactional write operation, using a second buffer associated with the memory access tracking logic, with respect to a second memory location;
execute at least one of: a non-transactional read operation with respect to a third memory location, or a non-transactional write operation with respect to a fourth memory location;
responsive to detecting, by the memory access tracking logic, access by a device other than the processor to at least one of the first memory location or the second memory location, abort the memory access transaction; and
responsive to failing to detect a transaction aborting condition and irrespectively of a state of the third memory location and a state of the fourth memory location, complete the memory access transaction.
